(19) United States
(12) Patent Application Publication
(10) Pub. No.: US 2005/0052549 A1
(43) Pub. Date: Mar. 10, 2005

(54) Digital camera and method of using

(76) Inventors: Charles E. Schinner, Windsor, CO (US); Theodore B. Ziemkowski, Loveland, CO (US); Amy E. Bottles, Windsor, CO (US); Douglas Gennetten, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/659,981

(22) Filed: Sep. 10, 2003

(51) Int. Cl. H04N 5/76; B41B 1/00; G06K 1/00; B41J 1/00; B41F 1/00; G06F 15/00

(52) U.S. Cl. 348/231.2; 348/231.4; 358/1.16

(57) ABSTRACT

A digital camera is disclosed herein. An embodiment of the digital camera comprises a memory device and a switching device. Image data generated by the digital camera is storable in the memory device. The memory device further comprises memory locations that are partitionable into a plurality of directories. The switching device has a first state and a second state, wherein image data is storable in a first of the plurality of directories. Image data is storable in a second of the plurality of directories when the switch is toggled from the first state to the second state.

### BACKGROUND

Digital cameras generate image data representative of images of objects. The process of generating image data is sometimes referred to as capturing the image or imaging the object. Image data representative of each individual image captured by the digital camera is typically stored in separate data files or image files within a memory device electrically connected to the digital camera. For example, the file may be stored within a solid state memory device or memory card that is electrically connected to the digital camera.

As the image files are generated, the digital camera stores the image files in the memory device and assigns file names to the image files. The files names do not necessarily define the image being captured. For example, when an image is captured, a file name, which usually consists of numbers, may be automatically assigned to the image file. This seemingly random file name assignment makes it difficult for a user of the digital camera to associate captured images with the assigned file names. Accordingly, it is difficult for a user to sort the images and to select specific images for processing.

Another problem with the above-described storage technique used by digital cameras occurs when a camera using a single memory device is used to capture images of multiple events. In such situations, the image files are stored in the memory device using the above-described file naming method. The user must then manually sort the image files in order to associate specific images with specific events. This sorting process may be accomplished by using a display device connected to the camera, a computer, or other methods. However, these sorting techniques are tedious and time consuming.

### SUMMARY

A digital camera is disclosed herein. An embodiment of the digital camera comprises a memory device and a switching device. Image data generated by the digital camera is storable in the memory device. The memory device further comprises memory locations that are partitionable into a plurality of directories. The switching device has a first state and a second state, wherein image data is storable in a first of the plurality of directories. Image data is storable in a second of the plurality of directories when the switch is toggled from the first state to the second state.

### BRIEF DESCRIPTION OF THE DRAWINGS

FIG. 1 is a rear perspective view of an embodiment of a digital camera.

FIG. 2 is a flowchart describing an embodiment of the operation of the digital camera of FIG. 1.

FIG. 3 is an embodiment of the memory structure of the memory device shown in the digital camera of FIG. 1.

FIG. 4 is an embodiment of the memory structure of FIG. 3 with the addition of subdirectories.

FIG. 5 is another embodiment of the memory structure of the memory device shown in the digital camera of FIG. 1.

FIG. 6 is graph showing an example of the number of images captured by the digital camera of FIG. 1 over a period of time.

FIG. 7 is an embodiment of the display device on the digital camera of FIG. 1 accepting user input for sorting criteria.

### DETAILED DESCRIPTION

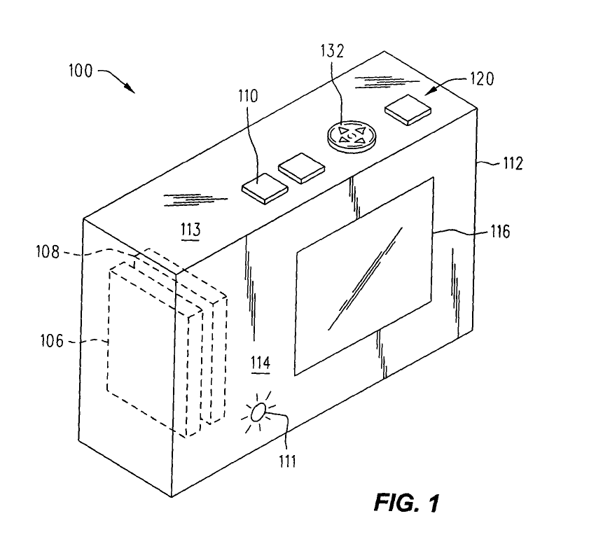

A digital camera is described herein, wherein an embodiment of the digital camera 100 is shown in FIG. 1. The digital camera 100 converts images of objects to machine-readable image data, sometimes referred to simply as image data. The process of generating image data representative of an object is sometimes referred to as capturing an image of the object or imaging the object.

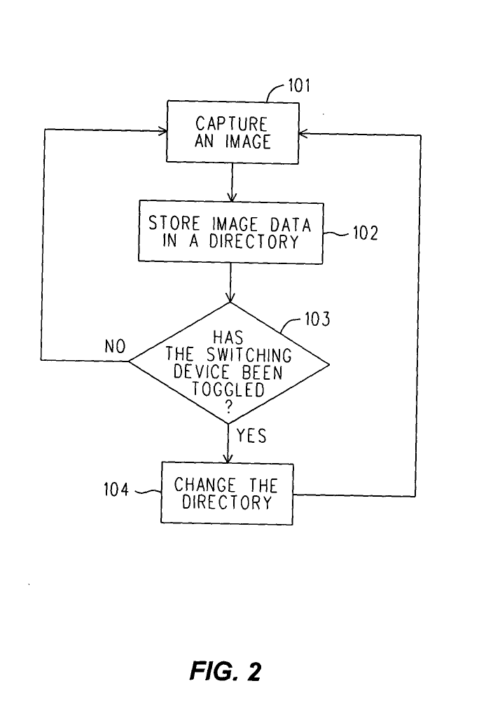

The digital camera 100 and its operation are summarily described below followed by more detailed descriptions. The operation of the digital camera 100 is also described in the flowchart of FIG. 2.

As shown in the flowchart of FIG. 2, images are captured by the digital camera 100 as shown in block 101 and stored in a directory as shown in block 102. The digital camera monitors a switching device to determine whether the switching device has been toggled as shown in block 103. If the switching device is toggled, image data representative of subsequent images is stored in a different directory as shown in block 104. If the switching device has not been toggled, the image data representative of subsequent images is stored in the same directory.

Referring again to FIG. 1, image data is typically stored as a plurality of image files in a memory device 106 that may be located within the digital camera 100. The image data may be processed by a processor 108 that is located within the digital camera 100. As described in greater detail below, the processor 108 may control other operations of the digital camera 100.

In one embodiment, each image file corresponds to image data representative of one captured image. As described in greater detail below, memory locations (not shown in FIG. 1) within the memory device 106 are partitionable into a plurality of directories or file folders. For example, the processor 108 may cause the memory locations to be partitioned into the above-described directories. Each of the directories may be partitionable into a plurality of subdirectories. Therefore, image files may be stored in plurality of different directories or subdirectories that are created by a user of the digital camera 100. As described in greater detail below, these directories serve to sort the image files and, thus, sort the captured images by criteria set by the user.

The digital camera 100 shown in FIG. 1, has a switching device 110 located thereon. The switching device 110 is sometimes referred to as a file folder switch 110. In one embodiment described in greater detail below, a microphone 111 may function in a manner similar to the file folder switch 110. As described in greater detail below the file folder switch 110 enables the user of the digital camera 100 to sort the image files into preselected directories and subdirectories instead of having the image files stored in randomly generated locations. The directories generated by the digital camera 100 are similar to directories used in personal computers.

A user may use the digital camera 100 with a single memory device 106 to capture images of multiple events, such as a birthday party and a picnic. By toggling the file folder switch 110, the user can create directories and subdirectories within the memory of the memory device 106 to store the image files generated at the two events. More specifically, the processor 108 may partition the memory locations within the memory device 106. Toggling the file folder switch 110 may involve, as examples, activating or inactivating the file folder switch 110. Therefore, the image files representative of images captured at the birthday party may be stored in one directory and the image files representative of images captured at the picnic may be stored in another directory. As described in greater detail below, the use of directories makes it easier for the user to sort the images. In addition, the directories are created simply by toggling the file folder switch 110.

Having summarily described the digital camera 100, it will now be described in greater detail.

The digital camera 100 may include, among other components, a housing 112 which may include, a top surface 113, a back surface 114, a display 116 and a plurality of switches 120. The display 116 may be used to display images captured by the digital camera 100 as well as menus and other information related to the operation of the digital camera 100. The display 116 also enables the user of the digital camera to scroll through and view directories and subdirectories created within the memory device 106. The display 116 may be controlled by the processor 108.

The plurality of switches 120 may include the above-described file folder switch 110 in addition to a navigation switch 132 and other various switches. In one embodiment of the digital camera 100, the navigation switch 132 functions similar to a joystick when used in conjunction with the display 116. For example, toggling or pressing the navigation switch 132 in a specific direction may cause a cursor displayed on the display 116 to move left, right, up or down. An item displayed on the display 116 may be selected by pressing the navigation switch 132 toward the housing 112 rather than in one of the above-described directions. Selecting an item may also be accomplished by pressing one of the other switches. The display 116 and switches 120 are shown in FIG. 1 as being on the top surface 113 of the digital camera 100, however, they may be located on other surfaces of the housing 112.

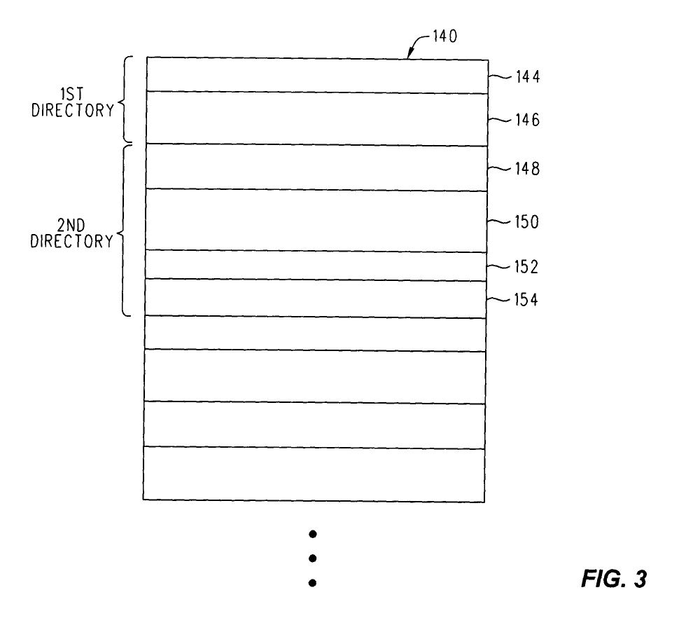

An embodiment of the memory structure of the memory device 106 is shown in FIG. 3. The memory structure may include a plurality of image data storage locations 140, sometimes referred to simply as storage locations 140. With additional reference to FIG. 1, a memory management device or program, not shown, within the digital camera 100 or a similar program or device located on the memory device 106 may sort and track the locations of data stored in the storage locations 140. The memory structure of FIG. 3 is presented for illustration purposes and does not include any subdirectories. In some embodiments, more complex memory structures may be used. For example, a single image file may be separated into several different portions and stored in as many different storage locations 140.

Six of the above-described storage locations 140 are referenced individually as a first location 144, a second location 146, a third location 148, a fourth location 150, a fifth location 152, and a sixth location 154. Even though only six data storage locations 140 are specifically referenced in FIG. 3, any number of data storage locations 140 may be present in the memory device 106. In the embodiment of the memory structure described herein, each data storage location 140 stores image data representative of one image. Thus, the amount of data stored at each of the data storage locations may vary depending on the amount of image data generated in capturing and processing the corresponding image. As described above, other memory management techniques may store image files differently.

The embodiment of the data storage locations 140 described herein are created sequentially as image data is generated. For example, when a first image is captured, its corresponding image data is stored in the first location 144, which causes the first location 144 to be generated or defined. Thus, the size of the first location 144 depends on the amount of image data generated in capturing and/or processing the first image. This embodiment is for illustration purposes only, and it is to be understood that other data management techniques may be used by the digital camera 100 and the memory device 106, FIG. 1.

With additional reference to FIG. 1, the data management system governing the memory device 106 associates each of the memory locations 140 with a directory. In one embodiment, memory locations 140 are associated with a single default directory until the user creates other directories as described in greater detail below. In the embodiment of the memory structure of FIG. 3, the first location 144 and the second location 146 are associated with a first directory and the remaining locations are associated with a second directory. The first directory may be a default directory. Accordingly, the first two images captured by the digital camera 100 may have been stored in the first default directory. The user may have decided to separate the remaining images from the first two images by creating the second directory. In any event, the user created the second directory for storing subsequent images. Other embodiments of the memory structure including the creation of subdirectories are described below.

Having described an embodiment of the memory structure, the process of generating directories and subdirectories will now be described. As described above, the digital camera 100 includes the file folder switch 110 that facilitates the generation, and in some embodiments, delineation, of directories. A new directory may be generated by toggling the file folder switch 110. For example, if the file folder switch 110 is a button, toggling may simply involve pressing the button. Other embodiments of the file folder switch 110, such as an audio switch, are described in greater detail below.

Toggling the file folder switch 110 causes a signal to be generated that in turn causes a new directory to be created within the memory device 106. With additional reference to FIG. 3, image data representative of images captured prior to toggling the file folder switch may be stored in the above-described default directory, which is referenced as the first directory. Image data representative of images captured subsequent to toggling the file folder switch 110 are stored in the second directory. The directories may be assigned numerical names, such as the first and second directories, by the digital camera 100. As described in greater detail below, the names of the file folders may be assigned by a user of the digital camera. In one embodiment as described below, the file names are created via voice or sound generated by the user of the digital camera 100.

When the images represented by the image data stored on the memory device 106 are viewed, they may be associated with the directories in which they are located. In one embodiment, the display 116 may list the directories of the memory device 106. File names assigned to individual image files may be associated with their respective directories. This embodiment enables a user to capture first images at a first event or a first time and store them in the first directory. Second images captured at a second event or second time may be stored in the second directory. The user may then view images captured at the first event or time without having to sort through images captured at the second event or time. The user may then capture images subsequent to the second images and store them in the first directory.

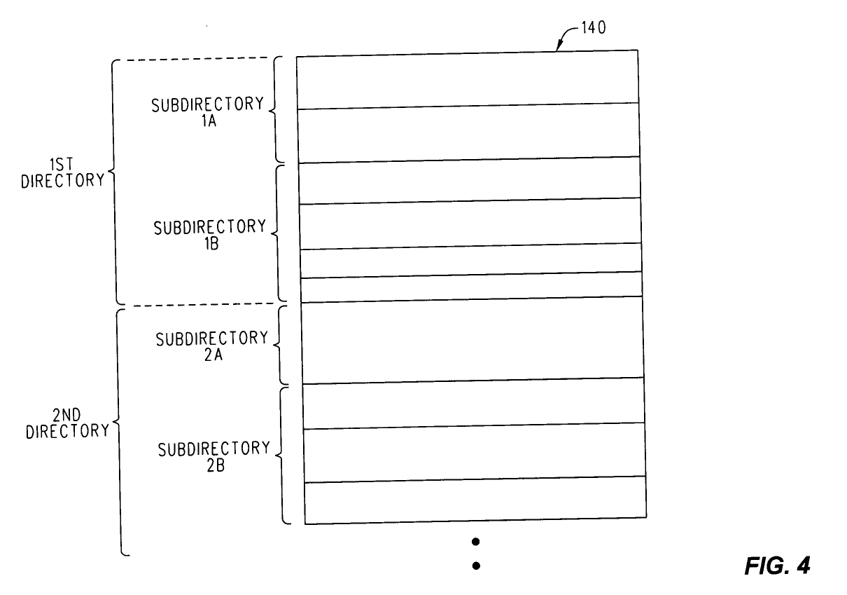

As briefly described above, the memory locations 140 within the memory device 106 may also be partitioned into subdirectories. An example of the use of subdirectories is provided in FIG. 4, which is an embodiment of the memory structure within the memory device 106. As shown in FIG. 4, the first directory is partitioned into two subdirectories referenced as subdirectory 1A and subdirectory 1B. The second directory is also partitioned into two subdirectories, subdirectory 2A and subdirectory 2B. The subdirectories may be generated in a similar manner as the directories were generated. For example, toggling the file folder switch 110 a preselected number of times within a preselected period may cause a subdirectory to be generated. The subdirectories may be further partitioned into a plurality of subdirectories.

Having described some basic embodiments of the digital camera 100, other embodiments will now be described.

In one embodiment, the file folder switch 110 may also be used to delete directories and subdirectories. For example, toggling the file folder switch 110 two times within a preselected period may cause the display 116 to display all above-described directories and their associated subdirectories. Selection of a specific directory or subdirectory for deletion may be accomplished by toggling the navigation switch 132. Upon selection of the file directory or subdirectory to be deleted, deletion may be accomplished by toggling a switch, such as the file folder switch 110.

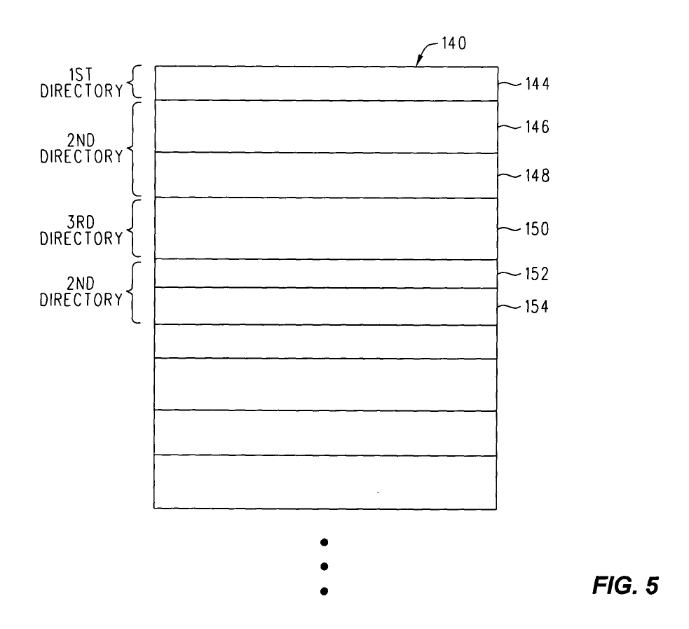

Another embodiment of the digital camera 100 is related to the memory structure, wherein an example of another embodiment of the memory structure is provided in FIG. 5. The memory structure of the embodiment of FIG. 5 is arranged so that the memory locations, and thus, the image files, are assigned to specific directories. In the example provided in FIG. 5, the first location 144 is assigned to the first directory. The second location 146 and the third location 148 are assigned to the second directory. The fourth location 150 is assigned to the third directory. The fifth location 152 and the sixth location 154 are assigned to the second directory. Such an arrangement of image files may be due to the digital camera 100 storing data file in chronological order. For example, the memory manager may have associated image data representative of a first image with the first directory, which may be a default directory. The user may have then used the file folder switch 110 to create the second directory. Subsequently, the user may have captured the second and third images, which the memory manager associated with the second directory. Subsequent to capturing the second and third images, the user may have caused the digital camera 100 to create the third directory, wherein the fourth captured image is associated with the third directory. Finally, the user may have captured the fifth image, which the user may have designated to be associated with the second directory. For example, the user may have instructed the digital camera 100 to designate an association between the fifth image or the location where the image data representative of the fifth image is stored and the second file folder. Accordingly, the images are sorted into directories as designated by the user.

Referring again to FIG. 1, another embodiment of the digital camera 100 involves different types of file folder switches 110. One embodiment of the digital camera 100 uses a heat sensitive device (not shown) for toggling. Thus, a user may place his or her finger over the file folder switch 110 in order to cause the file folder switch 110 to toggle. Another embodiment of the file folder switch toggles upon detection of sound by way of the microphone 111. The toggling may occur using voice recognition and may function in conjunction with the processor 108. Thus, the user of the digital camera 100 may simply speak instructions, such as “create directory” or “delete directory” into the microphone 111 in order to perform the above-described functions. This embodiment also enables the user to assign audible names to the directories, subdirectories, and image files. Therefore, a user may search for a specific image file by telling the camera to “search” for the image file. The search may also be limited to a specific directory or subdirectory.

Having described embodiments of the digital camera 100, embodiments of the sorting function will now be described.

As described above, an embodiment of the digital camera 100 has the ability to sort image data representative of different images into different directories and subdirectories as the image data is being generated. Another embodiment of the sorting procedures sorts image data after it has been generated. For example the digital camera 100, or a processor (not shown) associated with the digital camera 100 may sort image files into groups depending on the time in which the images were captured. The groups are directories or subdirectories as described above. This sorting technique may apply to situations where the digital camera 100 is used to capture images of a first event at a first time and images of a second event at a second time wherein no images are captured during the intervening period. The digital camera 100 may sort the images captured during the first time into a first directory and the images captured during the second time into a second directory.

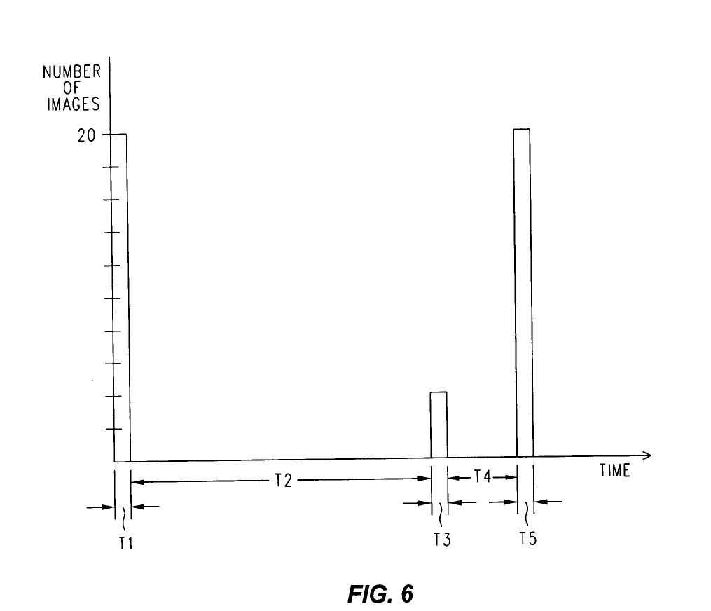

An example of a number of images captured over a period of time is shown in the graph of FIG. 6. During a period T1, the user captured 20 images. No images were captured during the period T2, which may be significantly longer than the period T1. During a period T3, the user captured 6 images. No images were captured during a period T4. Twenty images were captured during a period T5. In general, images captured during the period T1 are of a first event, images captured during the period T3 are of a second event, and images captured during the period T5 are of a third event. The digital camera 100, FIG. 1, may analyze the data represented in FIG. 6 in order to sort the image files into directories wherein images of different events are stored in different directories.

The digital camera 100 may analyze the data such as the data shown in FIG. 6 to determine that several images were captured during the period T1, which was followed by the period T2 when no images were captured. If the period T1 is much smaller than the period T2, the digital camera may assume that the images captured during the period T1 are of a single event and may create a directory to store their associated image files. The same may apply to the images captured during the periods T3 and T5. As shown in FIG. 6, the period T4 is relatively short. Depending on the criteria for sorting images, images captured during the period T3 and T5 may be grouped together in a directory or placed into separate directories.

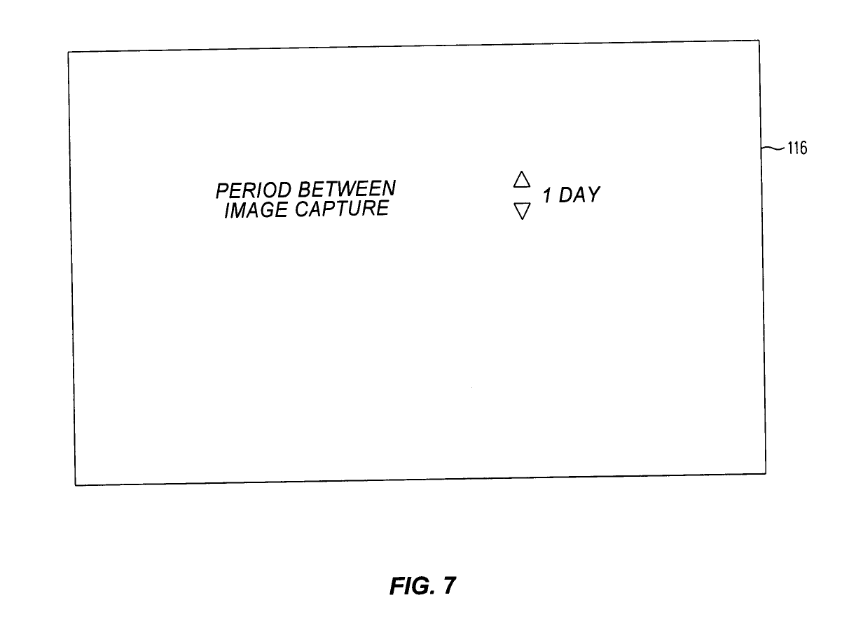

In one embodiment of the digital camera 100, the user may select the criteria for sorting image files. The digital camera 100 may include switches or the like that initiate user input to set the criteria for sorting the image files. For example, toggling the file folder switch 110 a plurality of times over a preselected period may cause the digital camera 100 to accept such input from the user. FIG. 7 shows an embodiment of the display 116 when the digital camera 100 is in a mode to accept user input related to sorting images. In the embodiment of FIG. 7, a user may select the period between images for sorting purposes. For example, a period of one day or more may be selected. Accordingly, periods of one day or more without any images being captured will cause new directories to be created.

With additional reference to FIG. 6, the user may select the period T2 and T4. If the period selected by the user is one day and the period T2 is greater than one day, the images generated during the period T1 will be stored in a separate directory. If the period T4 is less than one day, the images generated during the periods T3 and T5 will be stored in the same directory.

1. A digital camera comprising:
a memory device wherein image data generated by said digital camera is storable in said memory device, said memory device comprising memory locations that are partitionable into a plurality of directories; and
a switching device having a first state and a second state;
wherein image data is storable in a first of said plurality of directories; and
wherein image data is storable in a second of said plurality of directories when said switching device is toggled from said first state to said second state.

2. The digital camera of claim 1, wherein said switching device is toggled between said first state and said second state by audible signals.

3. The digital camera of claim 1, wherein said switching device is toggled between said first state and said second state upon detection of human voice.

4. The digital camera of claim 1, and further comprising a housing, wherein said switching devices comprises a member that extends from said housing, and wherein said switching device is toggled between said first state and said second state upon movement of said member.

5. The digital camera of claim 1, wherein, upon toggling of said switching device, image data generated during a first period is storable in said first directory and image data generated during a second period is storable in said second directory.

6. The digital camera of claim 1, wherein a directory is creatable upon toggling of said switching device.

7. The digital camera of claim 1, wherein at least one of said image files has an audio file name associated therewith.

8. The digital camera of claim 7, wherein said image files are searchable based on said audio file name.

9. A method of using a digital camera, said method comprising:
generating first image data;
storing said first image data in a first directory of a memory device; and
toggling a switching device associated with said digital camera;
wherein said toggling causes subsequent image data to be stored in a second directory of said memory device.

10. The method of claim 9, wherein said toggling comprises generating audio signals that are detectable by said switching device.

11. The method of claim 9, wherein said toggling comprises generating voice signals that are detectable by said switching device.

12. The method of claim 9, wherein said digital camera comprises a housing, wherein said switching devices comprises a member that extends from said housing, and wherein said toggling comprises moving said member.

13. The method of claim 9, wherein, upon toggling of said switching device, image data generated during a first period is stored in said first directory and image data generated during a second period is stored in said second directory.

14. The method of claim 9, wherein said toggling creates a directory within said memory device.

15. The method of claim 9, image data is stored within at least one image file having an audio file name associated therewith.

16. The method of claim 15, and further comprising searching said image files using audio signals.

17. A method of sorting image data generated by a digital camera, said method comprising:
generating first image data using said digital camera;
storing said first image data in a first directory within a memory device electrically connected to said digital camera; and
toggling a switching device associated with said digital camera, said toggling causing second image data to be stored in a second directory within said memory device.

18. The method of claim 17, wherein said toggling comprises detecting audible signals.

19. The method of claim 17, wherein said toggling comprises detecting voice signals.

20. The method of claim 17, wherein said digital camera comprises a housing, wherein said switching devices comprises a member that extends from said housing, and wherein said toggling comprises moving said member.

21. The method of claim 17, wherein, upon toggling of said switching device, image data generated during a first period is stored in said first directory and image data generated during a second period is stored in said second directory.

22. The method of claim 17, wherein said toggling creates a directory within said memory device.

23. The method of claim 17, image data is stored within at least one image file having an audio file name associated therewith.

24. The method of claim 23, and further comprising searching said image files using audio signals.

25. A digital camera comprising:
a memory means for storing image data generated by said digital camera, said memory means being partitionable into a plurality of directories; and
a switching means;
wherein toggling of said switching means causes image data to be stored in one of said plurality of directories.

26. A digital camera comprising a computer and a computer-readable medium operatively associated with said computer, said computer-readable medium containing instructions for:
storing first image data generated by said digital camera in a first directory of a memory device;
sensing toggling of a switching device; and
storing subsequent image data generated by said digital camera in a second directory of said memory device upon sensing said toggling of said switching device.
